(19) United States
(12) Patent Application Publication
(10) Pub. No.: US 2003/0166778 A1
(43) Pub. Date: Sep. 4, 2003

(54) Micro-composite polymer/polymer materials with semicrystalline dispersed phase and preparation method

(76) Inventors: Philippe Cassagnau, Millery (FR); Alain Michel, Lyon (FR)

Correspondence Address: YOUNG & THOMPSON, 745 SOUTH 23RD STREET 2ND FLOOR, ARLINGTON, VA, 22202

(21) Appl. No.: 10/240,939

(22) PCT Filed: Apr. 6, 2001
(86) PCT No.: PCT/FR01/01056

(30) Foreign Application Priority Data
Apr. 6, 2000 (FR) 00/04420

(51) Int. Cl. C08L 67/02

(52) U.S. Cl. 525/165

(57) ABSTRACT

The invention concerns a micro-composite polymer/polymer material comprising 25 to 35 wt. % of a semicrystalline polymer (I), forming a dispersed phase localised inside a thermoplastic or elastomeric polymer (II) forming a matrix, the temperature of crystallisation of the polymer forming a dispersed phase being higher by at least 20° C. than the melting or softening point of polymer (II) forming the matrix, and the dispersed phase of said material having specifically a morphology such that it induces crosslinking of the continuous phase. The invention also concerns a method for obtaining said material comprising steps which consist in: extruding, at regulated temperature, said mixture of melted polymers, said regulation temperature being decreasing from the feeding zone (A) to the die zone (F) of said extruding machine (1) so that the temperature of the material in said die zone (F) is lower than the temperature of recrystallisation or solidification of polymer (I) and higher than the melting or softening point of polymer (II); and cooling at room temperature the resulting micro-composite material.

The present invention relates to a process for producing polymer/polymer microcomposite materials by controlled-temperature extrusion and to the resulting microcomposite materials.

The expression “polymer/polymer microcomposite material” denotes a material comprising a blend of immiscible polymers, one of which forms a phase dispersed in the other, which constitutes the matrix.

Polymer/polymer microcomposite materials are generally prepared by extrusion at a constant temperature or at a temperature which increases substantially from the feed zone to the die, this extrusion step being followed by a drawing step and a quench on leaving the die, before being reprocessed for the intended applications.

In the case of semicrystalline polymers, the materials thus obtained have a dispersed phase of nodular or fibrillar morphology oriented in the drawing direction.

This morphology is not in general very stable and is often destroyed during subsequent reprocessing of the microcomposite material.

In general, the thermomechanical properties of currently available microcomposite materials are limited and insufficient for their subsequent processing.

One objective of the present invention is to provide polymer/polymer microcomposite materials having a dispersed phase of the semicrystalline polymer type and possessing improved thermomechanical properties.

Another objective of the invention is to provide a process for producing the aforementioned microcomposite materials that can be processed in a simple and reproducible manner with high contents of the dispersed phase.

Another objective of the invention is also to provide such a process for producing microcomposite materials as indicated above with improved thermomechanical properties.

Another objective of the present invention is to provide polymer/polymer microcomposite materials that can be used as starting materials in order to obtain shaped articles which retain their thermomechanical properties.

More specifically, according to a first aspect, the subject of the invention is a polymer/polymer microcomposite material comprising from 25 to 35% by weight of a semicrystalline polymer (I) forming a dispersed phase localized within a matrix-forming elastomer or thermoplastic polymer (II), the crystallization temperature of the dispersed-phase-forming polymer (I) being at least 20° C. above the melting point or softening temperature of the matrix-forming polymer (II) and the dispersed phase of said material specifically possessing a morphology such that it induces physical crosslinking of the continuous phase.

The subject of the invention is also a process for producing such composite materials, characterized in that it comprises the steps consisting in:

introducing, at a controlled temperature into the feed zone (F) of an extruder (1), a blend (2) comprising said polymers (I) and (II), this zone being above the melting point or softening temperature of each of the polymers of said blend (2);

extruding said polymer blend in the melt state at a controlled temperature, said control temperature decreasing from the feed zone (F) to the die zone (D) of said extruder (1) so that the material temperature in said die zone (D) is below the recrystallization or solidification temperature of the polymer (I) and above the melting point or softening temperature of the polymer (II); and

cooling the resulting microcomposite material to room temperature.

The invention also relates to a process for obtaining shaped articles, using, as starting material, a microcomposite material as mentioned above, at a controlled temperature, such that, throughout the formation of said shaped article, the material temperature remains below the melting point or softening temperature of the polymer forming the dispersed phase of the microcomposite material used.

The inventors have demonstrated that, by processing a blend of chosen polymers (or copolymers) by what is referred to as a “dynamic quench” process as defined below, it is possible to obtain, in a reproducible and stable manner, microcomposite materials with a semicrystalline dispersed phase having a flow threshold stress and having improved thermomechanical properties.

The invention will be described in greater detail below with reference to the drawings in which:

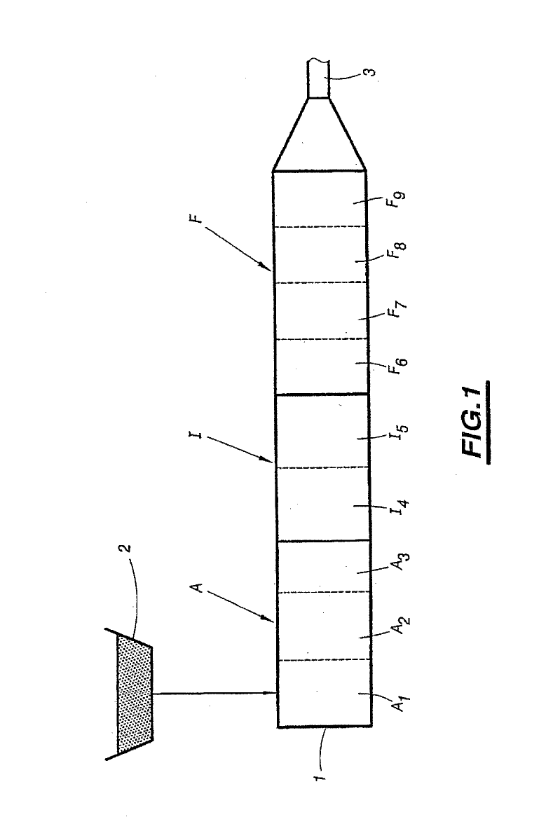

FIG. 1 shows diagrammatically the extrusion step of the process according to the invention;

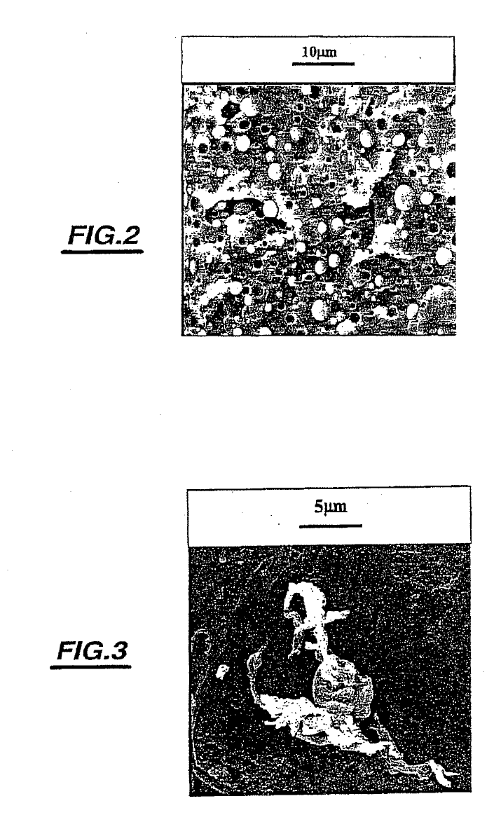

FIGS. 2 and 3 are photographs taken in a scanning electron microscope showing the morphology of materials obtained from a 70/30 ethylene-vinyl acetate (EVA)/polybutylene terephthalate (PBT) blend by a conventional process and by the dynamic quench process according to the invention, respectively; and

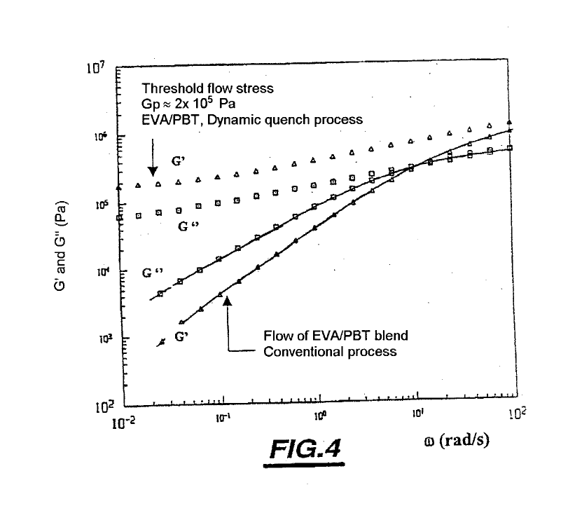

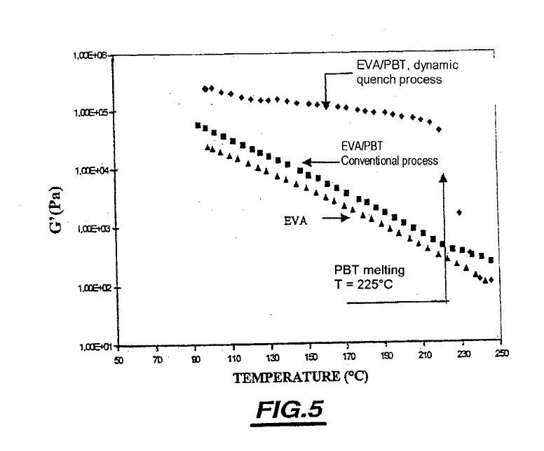

FIG. 4 is a comparative diagram indicating the curves of variation in the complex shear modulus G′ and G″ as a function of the stressing frequency, in linear viscoelasticity, of the materials of FIGS. 2 and 3 obtained, respectively, according to a conventional process (G′: -Δ-Δ- and G″: -□-□-), and according to the dynamic quench process of the invention (G′: Δ and G″: □), Gp being the flow threshold stress;

FIG. 5 is a comparative diagram showing the thermodynamic behavior (variation in the elastic modulus G′ as a function of temperature) of the materials of FIGS. 2 and 3 obtained according to a conventional process ( ) and according to the dynamic quench process of the invention (♦) respectively, and of the EVA alone ( ) at a stressing frequency ω of 1 rad/sec.

In general, during implementation of the process according to the invention, a blend comprising a polymer (I) intended to form the dispersed phase (called “dispersed-phase-forming polymer (I)”) and a polymer (II) intended to form the matrix (called “matrix-forming polymer (II)”) is firstly produced.

Within the context of the invention, the term “polymer” denotes, without distinction, one or more polymers and/or copolymers.

The polymers (I) and (II) used are specifically immiscible polymers. The term “immiscible polymers” denotes, within the context of the invention, polymers that are immiscible in the melt state under the conditions for processing them in order to produce the desired materials, and in the final extruded material.

The choice of polymers is made in such a way that the crystallization or solidification temperature of the polymer (I) intended to form the dispersed phase is substantially greater than the melting point or softening temperature of the matrix-forming polymer (II). The expression “substantially greater temperature” is understood to mean a difference of at least 20° C. between the temperatures in question and preferably a difference ranging from 30° C. to 50° C. A difference of about 30° C. (that is to say advantageously between 25 and 40° C., and typically between 28 and 35° C.) is more particularly preferred.

The matrix-forming polymer (II) may be chosen from semicrystalline or amorphous thermoplastic polymers or else from elastomers.

Among the examples of polymers suitable as the matrix-forming polymer (II), mention may be made of vinyl acetate and acrylic ester polymers or copolymers, more particularly of ethylene/vinyl acetate or ethylene/acrylic ester polymers or copolymers. Typically, the matrix is an ethylene/vinyl acetate polymer (EVA).

As regards the dispersed-phase-forming polymer (I), this is specifically a semicrystalline polymer.

Among semicrystalline polymers (I) suitable for the purposes of the invention, mention may be made of aromatic polyesters, polyamides, polyolefins, or blends thereof.

Typically mention may be made of polyethylene terephthalate and polybutylene terephthalate, poly-propylene and polyethylene or copolymers thereof or blends thereof in any proportions.

The process of the invention is specifically carried out in an extruder. A person skilled in the art is capable of choosing the characteristics of the extruder, especially so as to obtain relatively rapidly, by melt blending, a homogeneous blend of the polymers, taking into account the physico-chemical characteristics of the extruded material.

The extruder used according to the invention is preferably a twin-screw extruder, the length/diameter ratio of which is advantageously greater than or equal to 34.

The speed of rotation of the screws and the polymer feed rate may be adapted by a person skilled in the art so as to limit any self-heating and to meet the above-mentioned temperature condition.

FIG. 1 shows the barrel of an extruder 1 indicating, diagrammatically, in succession the feed zone F, an intermediate zone I and the die zone D which are subjected respectively to defined control temperatures as explained below. A die 3 is furthermore placed at the exit of the extruder.

The polymer blend 2 is introduced into the feed zone F of the extruder 1. The control temperature T_{feed} is above the melting point or softening temperature of each of the polymers of the blend. The polymers are then rapidly melt-blended so that the polymer forming the minority phase is dispersed homogeneously in the other polymer.

It will be recalled that, in general, the control temperature corresponds to the temperature (set temperature) applied to the barrel of the extruder and takes into account, in particular, the thermal phenomena that may occur in the installation and the self-heating of the processed material which may occur during the extrusion operation. The choice of the control temperature depends on the polymers used.

The extrusion operation is continued on the polymer blend in the melt state as far as the die zone D, where it will undergo a “dynamic quench”.

The expression “dynamic quench” denotes a controlled cooling operation carried out in the extruder, upstream of the die, which causes the dispersed-phase-forming polymer (I) to recrystallize or solidify in the matrix-forming polymer (II), under the shear forces and the mechanical stresses imposed by the extruder (rotation of the screws). A polymer/polymer microcomposite material with a specific and controlled morphology, having improved thermomechanical properties as explained below, is thus obtained.

For this purpose, the control temperature T_{die} in the die zone D is set so that the temperature of the material lying within this zone is below the recrystallization or solidification temperature of the polymer (I) intended to form the dispersed phase.

The control temperature T_{die} is advantageously at least 20° C. below the recrystallization or solidification temperature of the polymer (I) and is preferably 30° C. to 50° C. below this temperature.

The temperature in the die zone D is thus substantially below the temperature of the feed zone F and therefore follows a decreasing profile between said zones, passing through an intermediate zone I where the temperature Tᵢ is below that of the zone F but does not yet correspond to the “dynamic quench” temperature.

On exiting the die 3, the material is simply cooled to room temperature.

The process of the invention generally leads to the formation of microcomposite materials in which the dispersed phase has a specific morphology, called coral-type morphology, that is to say that it is generally in the form of discontinuous microstructures dispersed within the material and possessing many irregular branches.

An example of such a “coral”-type microstructure may be seen in FIG. 3 which, compared with FIG. 2, illustrates the difference in morphology obtained according to the “dynamic quench” process of the invention and according to a conventional process. In the case of a conventional process, like that used to obtain the material of FIG. 2, the quenching operation is carried out after the extrusion step, and in an independent manner, thereby obtaining a morphology of the nodular morphology type in FIG. 2.

Within the materials obtained, the average size of the microstructures of polymer (I) that are present in the dispersed phase is generally of the order of 1 to 5 μm. In particular in the case of microstructures of the “pieces of coral” type, this size is preferably of the order of one micron.

In the materials of the invention, the concentration of dispersed-phase-forming polymer (I) is specifically between 25% and 35% by weight (i.e. between 19% and 28% by volume) with respect to all of the polymers. In particular, so as not to obtain excessively brittle materials, it is often preferred that this content be less than 35% by weight and advantageously less than or equal to 33% by weight. Moreover, so as not to obtain threshold stresses that are too low, it is often preferred that this content be greater than 25% by weight, and advantageously greater than or equal to 27% by weight. This concentration is thus advantageously about 30% by weight (22% by volume) and it may thus typically be between 28 and 32% by weight.

The particular morphology obtained for the dispersed phase, in particular when this is a “coral”-type morphology, induces within the microcomposite materials of the invention a reinforcing effect caused by physical crosslinking.

The term “physical crosslinking” is understood, within the context of the invention, to mean a mechanical-type consolidation of the dispersed phase and of the continuous phase, which leads to a structuring of the continuous phase (and therefore of the material overall) by the dispersed phase.

It should be emphasized that physical crosslinking of the materials of the invention is especially to be distinguished from chemical-type crosslinking employed in other polymer/polymer composite materials known in the prior art, in which crosslinking of the phases is effected by creating chemical bonds, for example by addition of a crosslinking agent or by irradiation treatment. This is because the nature of “physical crosslinking” of the materials of the invention, due to the particular morphology of the dispersed phase, which consolidates the microstructures of the dispersed phase with the continuous phase, is radically different from chemical crosslinking. In particular, it should be noted that mechanical-type structuring, which characterizes the materials of the invention, does not fix the configuration of the material in a definitive manner, as is the case with chemical crosslinking.

Physical crosslinking of the composite materials of the invention makes it possible in particular to substantially reduce the flow phenomena in these materials at temperatures above the melting point or softening temperature of the matrix.

As a consequence, the materials obtained according to the process of the invention exhibit characteristic rheological properties, with in particular the existence of a flow threshold stress (denoted Gp) which is defined as being the value of the equilibrium elastic shear modulus (G′); Gp represents the limit of G′ as a function of ω [G′ (ω)] when ω tends toward 0. In other words, because of the physical crosslinking, materials are obtained in which flow can take place only when it is subjected to a certain stress.

Moreover, the dispersed phase of the composite materials obtained in accordance with the present invention retains its morphology as long as the material is employed, exhibiting in fine the same properties at temperatures below the melting point or softening temperature of the dispersed-phase-forming polymer.

The materials obtained according to the process of the invention therefore constitute useful intermediate products which can serve as starting materials for the manufacture of shaped articles. In this context, they may be processed using various techniques chosen according to the shaped article that it is desired to obtain. The processes for producing shaped articles using the microcomposite materials of the invention as starting materials may thus consist, for example, of one or more extrusion, injection-molding and/or compression-molding operations.

Whatever the treatment applied during formation of the shaped articles, the processing temperature of the microcomposite materials according to the invention (that is to say the material temperature) must remain below the melting point or softening temperature of the polymer (I) forming the dispersed phase. To this end, it is preferred that the processing temperature of the materials of the invention (material temperature) remains at least 20° C. below, and more preferably 30° C. to 50° C. below, the melting point or softening temperature of the polymer (I) forming the dispersed phase.

The processes for producing shaped articles using the microcomposite materials described above, under the abovementioned controlled temperature conditions, constitute one particular subject of the present invention.

The advantages and features of the present invention will be explained in greater detail in the light of the examples presented below.

### EXAMPLES

Equipment and Method

To produce the examples described below, a twin-screw extruder with corotating and interpenetrating screws was used. All the screw components had two flights. The diameter of the screws was 34 mm and the distance between the axes was 30 mm. The length/diameter (L/D) ratio of the extruder was L/D=34.

The barrel had nine successive and independent parts for controlling the temperature, defining three zones—the feed zone F, the intermediate zone I and the die zone D shown diagrammatically in FIG. 1.

These heating zones were also equipped with a pressurized-water circuit, controlled by a solenoid valve, for removing the heat produced by viscous dissipation of the polymers introduced by the mechanical sheer of the screws. This system allowed the self-heating phenomena to be considerably limited.

The various heating zones of the barrel are illustrated in FIG. 1.

The die consists of a flat die of the coat-hanger type, having the following dimensions: width L=50 mm, length 1=30 mm and thickness h=2 mm. The die was also controlled independently of the other zones, but did not have a water control system.

For the entire process described, the speed of rotation of the screws was set at 160 rpm and the total feed rate of the extruder was 3 kg/h. The two polymers (the matrix-forming polymer and the dispersed-phase-forming polymer) were introduced together into the feed zone F of the extruder.

The material temperature of the polymer was controlled by two infrared (IR) temperature sensors. These sensors allow the actual temperature of the molten polymers to be measured and controlled. They were placed in the intermediate zone I₄ and at the head of the die 3. A pressure sensor allowed the pressure at the entry of the die 3 to be measured and controlled.

Tensile tests were carried out on specimens cut using a blanking die on the extruded sheets. The values given for each specimen are the average of ten tests. The test pieces were of the H3 type according to the NF T51-034 Standard.

The test conditions were the following:

apparatus: INSTRON 1175 with self-clamping pneumatic jaws (1 kN load cell);

temperature: room temperature (23° C.);

test speed: 50 mm/min.

In terms of linear viscoelasticity, the flow threshold stress was measured at 120° C. The usage temperature range of the material is defined as being the range in which the material does not creep for applied stresses below the critical stress Gp (flow threshold). The usage temperature, defined according to this threshold stress criterion, must therefore be below the melting point or softening temperature of the dispersed phase.

### Example 1

EVA/PC Composite

The matrix consisted of an ethylene-vinyl acetate copolymer containing 28% vinyl acetate by weight. This is an Atochem copolymer with the commercial reference EVATANE 2803. Its melting point is 80° C. and its crystallization temperature about 50° C.

The dispersed phase was formed from polybutylene terephthalate (PBT), a DuPont polymer with the commercial reference CRASTIN. Its melting point is 225° C. and its crystallization temperature is 205° C.

30% by weight of PBT were dispersed in the EVA matrix using the process of the invention.

The temperature setpoints of the various control zones are given in Table 1:

TABLE 1

| | F | | | I | | D | | | | |
|---|---|---|---|---|---|---|---|---|---|---|
| Zones | 1 | 2 | 3 | 4 | 5 | 6 | 7 | 8 | 9 | die |
| T(° C.) | 250 | 250 | 250 | 230 | 170 | 110 | 110 | 110 | 110 | 110 |

The material temperatures indicated by the infrared sensors and the pressure measured in the die head are given in Table 2:

TABLE 2

| Sensors | T_{IR} (screws) | T_{IR} (die) | Pressure |
|---|---|---|---|
| Measurements | 240° C. | 138° C. | 65 bar |

A novel morphology of the PBT phase is obtained by giving the composite material a reinforcing effect allowing the flow phenomenon of the material at temperatures above the melting point of the EVA matrix to be considerably reduced.

At 120° C., a flow threshold stress (G′→Gp for ω→0) close to 10⁵ Pa is obtained, as illustrated in FIG. 4.

Furthermore, the rheological curves show that this reinforcing effect results from physical crosslinking of the material. FIG. 5 shows that the blend retains all its physically-crosslinked-network thermomechanical properties (zero flow of the specimen for stresses below Gp) as long as the application temperature of the material does not exceed 225° C., which is the melting point of PBT.

FIG. 4 shows the linear viscoelasticity flow curves and the variations in the moduli G′ and G″ (G′=elastic shear modulus; G″=viscous shear modulus) as a function of the stressing frequency.

FIG. 5 shows the thermomechanical behavior of the materials for a stressing frequency ω of 1 rad/s.

### Comparative Example 1

In a conventional process for producing a polymer blend, the dispersed phase has a nodular morphology as shown in FIG. 2.

The linear viscoelasticity flow curves obtained show that, at a temperature of 120° C. at which EVA is in the melt state and PBT is in the filler state, the material still retains its flow region. Only a filler effect on the viscosity is observed, without in any way preventing material from flowing. Consequently, the thermomechanical properties of the blend are completely lost once the melting point of the EVA matrix (Tₘ=80° C.) is exceeded, as illustrated in FIG. 4. The material therefore flows. The dispersed phase has merely a reinforcing effect, increasing the viscosity of the system, as shown in FIG. 5.

The measured thermomechanical properties are compared in Table 3 with the control specimens obtained by a conventional processing method on the same extruder (identical rate and identical screw speed).

TABLE 3

| | | | Tensile | Elongation | |
|---|---|---|---|---|---|
| | Threshold | | Strength | at break | Young's |
| | stress at | Usage | at 23° C. | at 23° C. | Modulus |
| Specimens | 120° C. | Temperature | (MPa) | (%) | (MPa) |
| Control | / | <80° C. | 4 | 500 | 50 |
| Invention | 10⁵ Pa | <225° C. | 3.5 | 250 | 100 |

### Example 2

EVA/PET Composite.

The matrix consisted of an ethylene-vinyl acetate copolymer containing 28% vinyl acetate by weight. This copolymer is the same as that used in example 1.

The dispersed phase was formed from polyethylene terephthalate (PET), an Eastman polymer with the commercial reference EASTAPAK PET, Copolyester 921. Its melting point is 240° C. and its crystallization temperature is 220° C.

30% by weight of PET were dispersed in the EVA matrix using the process of the invention.

The temperature setpoints of the various temperature control zones are given in Table 4:

TABLE 4

| | F | | | I | | D | | | | |
|---|---|---|---|---|---|---|---|---|---|---|
| Zones | 1 | 2 | 3 | 4 | 5 | 6 | 7 | 8 | 9 | die |
| T(° C.) | 270 | 270 | 270 | 240 | 200 | 140 | 140 | 140 | 140 | 140 |

The material temperatures indicated by the infrared sensors and the pressure measured in the die head are given in Table 5:

TABLE 5

| Sensors | T_{IR} (screws) | T_{IR} (die) | Pressure |
|---|---|---|---|
| Measurements | 250° C. | 160° C. | 60 bar |

The measured thermomechanical properties are compared in Table 6 with the control specimens obtained by a conventional processing method on the same extruder (identical rate and identical screw speed).

TABLE 6

| | | | Tensile | Elongation | |
|---|---|---|---|---|---|
| | Threshold | | Strength | at break | Young's |
| | stress at | Usage | at 23° C. | at 23° C. | Modulus |
| Specimens | 120° C. | Temperature | (MPa) | (%) | (MPa) |
| Control | / | <80° C. | 10 | 300 | 90 |
| Invention | 10⁵ Pa | <240° C. | 8 | 60 | 200 |

### Example 3

EVA/PP Composite.

The matrix consisted of an ethylene-vinyl acetate copolymer containing 28% vinyl acetate by weight. This copolymer is the same as that used in examples 1 and 2.

The dispersed phase was formed from polypropylene (PP), an Appryl semicrystalline polymer with the commercial reference APPRYL 3120. Its melting point is 165° C. and its crystallization temperature is 135° C.

30% by weight of PP were dispersed in the EVA matrix using the process of the invention.

The temperature setpoints of the various temperature control zones are given in Table 7:

TABLE 7

| | F | | | I | | D | | | | |
|---|---|---|---|---|---|---|---|---|---|---|
| Zones | 1 | 2 | 3 | 4 | 5 | 6 | 7 | 8 | 9 | die |
| T(° C.) | 240 | 240 | 240 | 200 | 150 | 90 | 90 | 90 | 90 | 90 |

The material temperatures indicated by the infrared sensors and the pressure measured in the die head are given in Table 8:

TABLE 8

| Sensors | T_{IR} (screws) | T_{IR} (die) | Pressure |
|---|---|---|---|
| Measurements | 250° C. | 160° C. | 60 bar |

The measured thermomechanical properties are compared in Table 9 with the control specimens obtained by a conventional processing method on the same extruder (identical rate and identical screw speed).

TABLE 9

| | | | Tensile | Elongation | |
|---|---|---|---|---|---|
| | Threshold | | Strength | at break | Young's |
| | stress at | Usage | at 23° C. | at 23° C. | Modulus |
| Specimens | 120° C. | Temperature | (MPa) | (%) | (MPa) |
| Control | 5 · 10³ | <80° C. | 6 | 950 | 50 |
| Invention | 2 · 10⁵ Pa | <165° C. | 5 | 160 | 100 |

### Example 4

EVA/PP Composite.

The matrix consisted of an ethylene-vinyl acetate copolymer containing 40% vinyl acetate by weight. This copolymer is an Atochem product with the commercial reference EVATANE 4055. Its melting point is 40° C. and its crystallization temperature is 25° C.

The dispersed phase consisted of polypropylene (PP) identical to the PP used in example 3.

25% by weight of PP were dispersed in the EVA matrix using the process of the invention.

The temperature setpoints of the various temperature control zones are given in Table 10:

TABLE 10

| | F | | | I | | D | | | | |
|---|---|---|---|---|---|---|---|---|---|---|
| Zones | 1 | 2 | 3 | 4 | 5 | 6 | 7 | 8 | 9 | die |
| T(° C.) | 240 | 240 | 240 | 200 | 150 | 90 | 90 | 90 | 90 | 90 |

The material temperatures indicated by the infrared sensors and the pressure measured in the die head are given in Table 11:

TABLE 11

| Sensors | T_{IR} (screws) | T_{IR} (die) | Pressure |
|---|---|---|---|
| Measurements | 225° C. | 115° C. | 70 bar |

The measured thermomechanical properties are compared in Table 12 with the control specimens obtained by a conventional processing method on the same extruder (identical rate and identical screw speed).

TABLE 12

| | | | Tensile | Elongation | |
|---|---|---|---|---|---|
| | Threshold | | Strength | at break | Young's |
| | stress at | Usage | at 23° C. | at 23° C. | Modulus |
| Specimens | 120° C. | Temperature | (MPa) | (%) | (MPa) |
| Control | / | <40° C. | 2 | 800 | 20 |
| Invention | 10⁵ Pa | <165° C. | 2 | 350 | 35 |

### Example 5

ENGAGE/PP Composite.

The matrix consisted of an ethylene-octene copolymer. This copolymer was a DuPont Low Elastomers product with the commercial reference ENGAGE 8100. This copolymer is an elastomer whose melting point is 60° C.

The dispersed phase of the invention consisted of polypropylene (PP) identical to the PP used in examples 3 and 4.

30% by weight were dispersed in the EVA matrix using the process of the invention.

The temperature setpoints of the various temperature control zones are given in Table 13:

TABLE 13

| | F | | | I | | D | | | | |
|---|---|---|---|---|---|---|---|---|---|---|
| Zones | 1 | 2 | 3 | 4 | 5 | 6 | 7 | 8 | 9 | die |
| T(° C.) | 240 | 240 | 240 | 200 | 150 | 90 | 90 | 90 | 90 | 90 |

The material temperatures indicated by the infrared sensors and the pressure measured in the die head are given in Table 14:

TABLE 14

| Sensors | T_{IR} (screws) | T_{IR} (die) | Pressure |
|---|---|---|---|
| Measurements | 230° C. | 120° C. | 90 bar |

The measured thermomechanical properties are compared in Table 15 with the control specimens obtained by a conventional processing method on the same extruder (identical rate and identical screw speed).

TABLE 15

| | | | Tensile | Elongation | |
|---|---|---|---|---|---|
| | Threshold | | Strength | at break | Young's |
| | stress at | Usage | at 23° C. | at 23° C. | Modulus |
| Specimens | 120° C. | Temperature | (MPa) | (%) | (MPa) |
| Control | / | <60° C. | 8 | 1000 | 20 |
| Invention | 10⁵ Pa | <165° C. | 8 | 250 | 40 |

1. A polymer/polymer microcomposite material comprising from 25 to 35% by weight of a semicrystalline polymer (I) forming a dispersed phase localized within a matrix-forming elastomer or thermoplastic polymer (II), the crystallization temperature of the dispersed-phase-forming polymer (I) being at least 20° C. above the melting point or softening temperature of the matrix-forming polymer (II) and the dispersed phase of said material possessing a morphology such that it induces physical crosslinking of the continuous phase.

2. The material as claimed in claim 1, characterized in that the concentration of dispersed-phase-forming polymer (I) is between 28% and 32% by weight.

3. The material as claimed in claim 1 or claim 2, characterized in that the dispersed-phase-forming semicrystalline polymer (I) is chosen from aromatic polyesters, polyamides, polyolefins, or blends thereof.

4. The material as claimed in claim 1 or claim 2, characterized in that the dispersed-phase-forming polymer (I) is chosen from polyethylene terephthalate and polybutylene terephthalate.

5. The material as claimed in claim 1 or claim 2, characterized in that the dispersed-phase-forming polymer (I) is chosen from polypropylene and polyethylene or copolymers thereof.

6. The material as claimed in any one of the preceding claims, characterized in that the dispersed phase has a coral-type morphology.

7. The material as claimed in any one of the preceding claims, characterized in that the dispersed phase is in the form of discontinuous microstructures of polymer (I) having an average size of between 1 and 5 μm.

8. The material as claimed in any one of the preceding claims, characterized in that the matrix-forming polymer is chosen from vinyl acetate and acrylic ester polymers or copolymers.

9. The material as claimed in claim 15, characterized in that the matrix-forming polymer is chosen from ethylene/vinyl acetate or ethylene/acrylic ester polymers or copolymers.

10. The material as claimed in claim 9, characterized in that the matrix-forming polymer is ethylene-vinyl acetate (EVA).

11. A process for producing a polymer/polymer microcomposite material as claimed in any one of claims 1 to 10, characterized in that it comprises the steps consisting in:
introducing, at a controlled temperature into the feed zone (F) of an extruder (1), a blend (2) comprising said polymers (I) and (II), this zone being above the melting point or softening temperature of each of the polymers of said blend (2);
extruding said polymer blend in the melt state at a controlled temperature, said control temperature decreasing from the feed zone (F) to the die zone (D) of said extruder (1) so that the material temperature in said die zone (D) is below the recrystallization or solidification temperature of the polymer (I) and above the melting point or softening temperature of the polymer (II); and
cooling the resulting microcomposite material to room temperature.

12. The process as claimed in claim 11, characterized in that the control temperature in the die zone (D) is at least 20° C. below the recrystallization or solidification temperature of the polymer (I).

13. The process as claimed in claim 12, characterized in that the control temperature in the die zone (D) is 30° C. to 50° C. below the recrystallization or solidification temperature of the polymer (I).

14. The process as claimed in any one of claims 11 to 13, characterized in that the polymer blend is extruded in the melt state in a twin-screw extruder.

15. The process as claimed in claim 14, characterized in that the extruder has a length/diameter (L/D) ratio of greater than or equal to 34.

16. A process for producing a shaped article, using as starting material a microcomposite material as claimed in any one of claims 1 to 10, or a microcomposite material obtained from a process as claimed in any one of claims 10 to 15, the temperature being controlled during formation of said shaped article in such a way that the material temperature remains below the melting point or softening temperature of the polymer (I) forming the dispersed phase of said microcomposite material.

17. The process as claimed in claim 16, characterized in that the material temperature remains at least 20° C. below the melting point or softening temperature of the polymer (I) forming the dispersed phase of the microcomposite material.
